(19) United States
(12) Patent Application Publication
(10) Pub. No.: US 2002/0065762 A1
(43) Pub. Date: May 30, 2002

(54) Method and visual interface for evaluating multi-attribute bids in a network environment

(76) Inventors: Ho Soo Lee, Mount Kisco, NY (US); Juhnyoung Lee, Yorktown Heights, NY (US)

Correspondence Address: McGuire Woods, LLP, Tysons Corner, Suite 1800, 1750 Tysons Boulevard, McLean, VA, 22102-3915, US

(21) Appl. No.: 09/800,664

(22) Filed: Mar. 8, 2001

Related U.S. Application Data
(63) Continuation-in-part of application No. 09/723,236, filed on Nov. 28, 2000.

(51) Int. Cl. G06F 17/60

(52) U.S. Cl. 705/37; 705/26

(57) ABSTRACT

A method for purchasing and selling products or services in a networked environment using a request for quotation process and a visual interface for evaluating submitted bids for such products or services. A buyer submits a Request for Quotation (RFQ) and associated attributes and/or business rules over a network. As seller responds to the RFQ by submitting a bid with attribute values. A market maker uses the buyer attributes and/or business rules with the attribute values of the submitted bid to create a visual interface augmented by customized filters which are later used to evaluate seller submitted bids. The bids are received in the e-marketplace, at which time the e-marketplace can arrange, sort or filter the received bids in order to assist the buyer in examining and evaluating such bids. The filtering may include filtering an attribute value, an attribute line, a bid line or a portion of the bid line. Information may also be displayed associated with the bid line such as attribute information, general information or detailed information. The bid lines may also be tagged, counted, scrolled, enlarged or reduced.

### CROSS-REFERENCE TO RELATED APPLICATION

This application is a continuation in part application of copending U.S. patent application Ser. No. 09/723,236 filed Nov. 28, 2000, by Ho Soo Lee and Juhnyoung Lee for “Method and Visual Interface for Evaluating Multi-Attribute Bids in a Network Environment” (IBM Docket YOR9-2000-0713US1), and assigned to common assignee herewith. The present application claims the benefit of priority to U.S. patent application Ser. No. 09/723,236.

### BACKGROUND OF THE INVENTION

1. Field of the Invention

The present invention generally relates to on-line purchasing of products or services over a computer network and, more particularly, to a method for purchasing and selling products or services in a networked environment using a request for quotation process and a visual interface for evaluating submitted bids for such products or services.

2. Background Description

Commerce over networks, particularly electronic commerce (ecommerce) over the Internet, has increased significantly over the past few years. In e-commerce models, buyers and sellers make trades, e.g., buy and sell services or products, over the World Wide Web portion of the Internet. In one example, one or more web pages, typically referred to as an electronic marketplace (e-marketplace), provide one or more different forms of trading mechanisms including auctions, reverse auctions, and exchanges. In an auction, one seller receives bids from one or more buyers for one or more products before making a transaction. In contrast, a reverse auction allows one buyer to receive bids from one or more potential sellers. In an exchange, multiple buyers and multiple sellers submit asks and bids, respectively, to a marketplace. The marketplace then makes matches between the asks and bids of the buyers and sellers either continuously or periodically.

It is known, of course, that these trading models have many different variations. These auction variations may include English (buyers call ascending prices), Dutch (market manager calls descending prices to obtain buy bids), Japanese (market manager calls ascending prices to obtain buy bids), and sealed bid (buyers place sealed bids) auctions. In still other variations of auctions, there is an open Request for Bids and a sealed Request For Bids. In the open Request for Bids, buyers may call ascending prices and a seller manually selects the winning price. In the sealed Request for Bids buyers submit sealed bids and a seller manually selects the winning bid.

There are also variations on reverse auctions which include reverse English (sellers call descending prices), reverse Dutch (market manager call ascending prices to obtain sell bids), reverse Japanese (market manager calls descending prices to obtain sell bids), and reverse sealed bid (sellers place sealed bids) auctions. Reverse auctions further include open Request For Quotes and sealed Request For Quotes. In the open Request for Quotes, the sellers call descending prices and a buyer manually selects a winning price, and in the sealed Request for Quotes the sellers submit sealed bids and a buyer manually selects the winning quote. Exchanges also include variations. These variations include continuously clearing exchanges and periodically clearing exchanges.

The Request for Quotation (RFQ) is used often in the e-marketplace. In this type of environment, a request is submitted by a buyer to an e-marketplace to invite potential sellers to bid on specific products or services needed by the buyer. The RFQ process is useful in all markets that depend upon attributes other than price such as delivery time, quantity discounts and the like. In these RFQ processes, the buyers are permitted to manually select one or more bids from sellers after examining and comparing submitted sell bids. In this manner, the RFQ process allows the sellers to match exactly the buyers' requirements (including the attributes of price, delivery time and the like) thus leading to a strong rate of return and high satisfaction ratings.

In RFQ processes, it is currently known that certain computer tools may be used to assist the buyers in evaluating and comparing the submitted sell bids. One example is the scoring function of Perfect.com's™ RFQ engine. This tool allows a buyer, when submitting an RFQ, to specify the subjective importance of relevant factors of products or services such as quantity, material quality, product quality ratings, merchant reputation, warranty, support, delivery time, delivery cost as well as price and other features. Once the bids are received from the sellers, the RFQ engine filters the sell bids by using the buyer's criteria, calculates the scores of individual bids by using the buyer's profile and a scoring function, and ranks such bids by score. The buyer, when presented with the filtered sell bids with associated ranks, may then select a winning bid. The use of bid ranking by score of individual sell bids assists the buyer in selecting the winning bids without having to analyze and evaluate lengthy unstructured text documents describing product attributes and other factors relevant to the purchase.

However, systems such as the Perfect.com™ RFQ engine may oversimplify the bid selection process for buyers in some cases. Thus, this type of system may not accurately reflect the bids such that the buyers may misjudge submitted bids or need to examine lengthy unstructured text description on product or service attributes to understand and confirm the bid ranking. This can be a time consuming and tedious task.

By way of another example, FIG. 1 shows a flow chart of a RFQ process using a conventional system. In FIG. 1, a buyer submits an RFQ for one or more products or services with a set of attribute preference to an e-marketplace (step 100). The attribute preference may include product attributes and other relevant factors such as price, quantity, material quality, product quality ratings, merchant reputation, warranty, support, delivery time, and delivery cost. The attribute preference submitted by the buyer will be used later for evaluating received sell bids by the market maker (FIG. 2). Also, the buyer is allowed to specify a criterion for the termination of the RFQ typically in a form of time and date for termination. To help buyers specify all this information about an RFQ and also to automate the matching process of an RFQ and submitted sell bids, the market maker of the e-marketplace may provide a structured form (as one or more Web pages) for all the data entries. The market maker may also store the submitted information about the RFQ in a database system of the e-marketplace.

In step 105, the submitted RFQ is posted on the e-marketplace for a time period specified by the buyer. The attribute preference of the RFQ may or may not be revealed to potential sellers in the e-marketplace depending on the market type. In step 110, one or more sellers respond to the RFQ by submitting bids to the e-marketplace. The sellers may, at this step, specify various relevant factors in the bids including price, quantity, etc. To assist the sellers, the market maker of the e-marketplace may provide a structured form (as one or more Web pages) for all the data entries, and may also automate the matching process of an RFQ and submitted bids. The market maker may store the information about the submitted sell bids in the database system in step 115.

When the RFQ is terminated by the criterion specified by the buyer, the market maker, in step 120, processes the newly submitted sell bids before presenting the sell bids to the buyer. This processing may include, for example, filtering out bids that do not meet any one or more of the attribute preferences. The market maker may also rank and sort the sell bids by a score that is calculated by using one or more scoring algorithms. In an alternative approach, the buyer may simply retrieve the RFQ and sell bids from the database system and examine the bids manually.

In step 125, the list of the processed sell bids is presented to the buyer. In step 130, the buyer then examines the sell bids in the list, and then evaluates the sell bids in order to select one that most meets the buyer's needs. Optionally, in step 135, the buyer can request more information about one or more of the sell bids in the list. To help provide this information, the market maker may provide one or more hyper-links for each bid to Web pages that provide more information about the sell bid. In addition, the buyer may request more information which is not readily available, in which the market maker may provide contact information including phone number, fax number, and/or an email address of sellers in the sell bid list. After finishing the evaluation of sell bids, in step 140, the buyer selects one or more sell bids from the given list. Finally, in step 145, the buyer purchases products or services from the selected sell bids.

FIG. 2 is an example of a list of sell bids ranked by score using the conventional system of FIG. 1. The list 200 may show, for example, rank 202, score 203, bid name 204, seller name 205, price 206, an information button 207 and a buy button 208. The list 200 may also show sell bids 209, 210 and 211 ranked by score. The bid names 204 as well as information buttons 207 may be hyper-links to Web pages. The hyper-links to the information pages may provide detailed information of individual bids in an unstructured text format.

Values of each of these relevant factors along with the importance value or “weight” of each factor specified by the buyer of the RFQ are used to calculate the score of individual bids. When the market maker processes submitted sell bids and presents the list 200 to the buyer, the buyer is capable of examining different sell bids by comparing ranks 202 and scores 203 and reading attribute information in web pages reachable from the information buttons 207. When the buyer selects one or more bids from the list 200 after examination, the buyer may then purchase the products or services simply by clicking on the buy buttons 208 and providing payment information.

A problem with the conventional method of FIGS. 1 and 2 is that representing multiple attribute values of products or services with a single number may hide important information useful for bid selection from buyers. For example, it is impossible to distinguish non-dominated bids from dominated bids by simply evaluating the score values of sell bids. (A bid (Bid “A”) is dominated by another bid (Bid “B”) if the value of each attribute of Bid “A” is not better than that of each corresponding attribute of Bid “B”.)

Another problem with the conventional method is that it is arbitrary and often extremely difficult for buyers to correctly and effectively assign importance value or “weight” to different attributes of a product or service. This fact is especially true when the buyer is not given any information about the algorithm of the scoring function, i.e., how the scoring function uses the weights of different attributes to generate a single score for different bids. In this manner, the score may be arbitrarily assigned or in an unintended way.

Yet another problem with the weight assignment is that it is impossible to express relationships among different attributes. For example, a buyer may have a tradeoff relationship between price and delivery time of a product; namely, the buyer may be willing to pay more for a product or service if the product or service can be delivered within a short period of time. However, it is not sufficient to express this kind of relationship among two attributes with an assignment of single weight value to each attribute.

### SUMMARY OF THE INVENTION

An object of the present invention is to provide a method for evaluating RFQ processes over a network.

An object of the present invention is to provide a method for evaluating submitted sell bids having two or more attributes over a network.

An object of the present invention is to provide a method for evaluating submitted sell bids having two or more attributes while not requiring any assignment of weights to individual product or service attributes.

An object of the present invention is provide a method for filtering attributes associated with sell bids having two or more attributes.

An object of the present invention is to provide a method for filtering dominated bids.

An object of the present invention is to provide a visual interface for buyers of Request for Quotation (RFQ) processes over a network.

An object of the present invention is to provide a visual interface which shows all the attributes values of the product or service in a single screen.

An object of the present invention is to provide a visual interface having a set of filters which can be dynamically customized by business rules.

An object of the present invention is to provide a visual interface which allows a buyer to select or deselect filters in order to compare different sell bids under different conditions.

An object of the present invention is to provide a visual interface which allows a buyer to inspect information of individual sell bids.

An object of the present invention is to provide a visual interface which allows a buyer to display information of individual sell bids such as attribute values in text or other media form.

An object of the present invention is to provide a visual interface which allows a buyer to tag one or more sell bids so that the tagged bid lines remain in the visual interface unaffected by filtering operations until they are untagged.

An object of the present invention is to provide a visual interface which allows a buyer to enlarge or reduce the size of the view of the sell bids.

An object of the present invention is to provide a visual interface displaying the number of bid lines shown in the interface.

In one aspect of the invention, a method of purchasing products and services over a network is provided. The method has the steps of submitting a Request for Quotation (RFQ) with at least one attribute over the network. The at least one bid, in response to the RFQ, is received over the network. It is noted that the at least one bid has at least one attribute value associated therewith. A graphical visual interface is then created based on a Cartesian coordinate system. The graphical user interface shows a relationship in a graphical format between the at least one attribute and the at least one bid and associated attribute value in a single display. Information pertinent to a selected bid is then displayed.

In another aspect of the present invention, the graphical format are sell bid lines created from connected attribute values of the at least one bid. The sell bid lines may be tagged to ensure that the sell bid lines remain displayed on the graphical user interface after a filtering operation.

In still another aspect of the present invention, a system for purchasing products and services over a network is provided. In this system, a mechanism is provided for submitting a Request for Quotation (RFQ) with at least one attribute over the network. Also provided is a mechanism which receives at least one bid in response to the RFQ over the network and a mechanism for creating a graphical visual interface based on a Cartesian coordinate system showing a relationship in a graphical format between the at least one attribute and corresponding attribute value in a single display. A further mechanism provides information associated with a selected bid.

In yet another aspect of the present invention, a machine readable medium containing code for purchasing products and services over a network is provided. The steps enumerated above are representative of the code for purchasing the products and services.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a flow chart of a conventional Request for Quotation (RFQ) process;

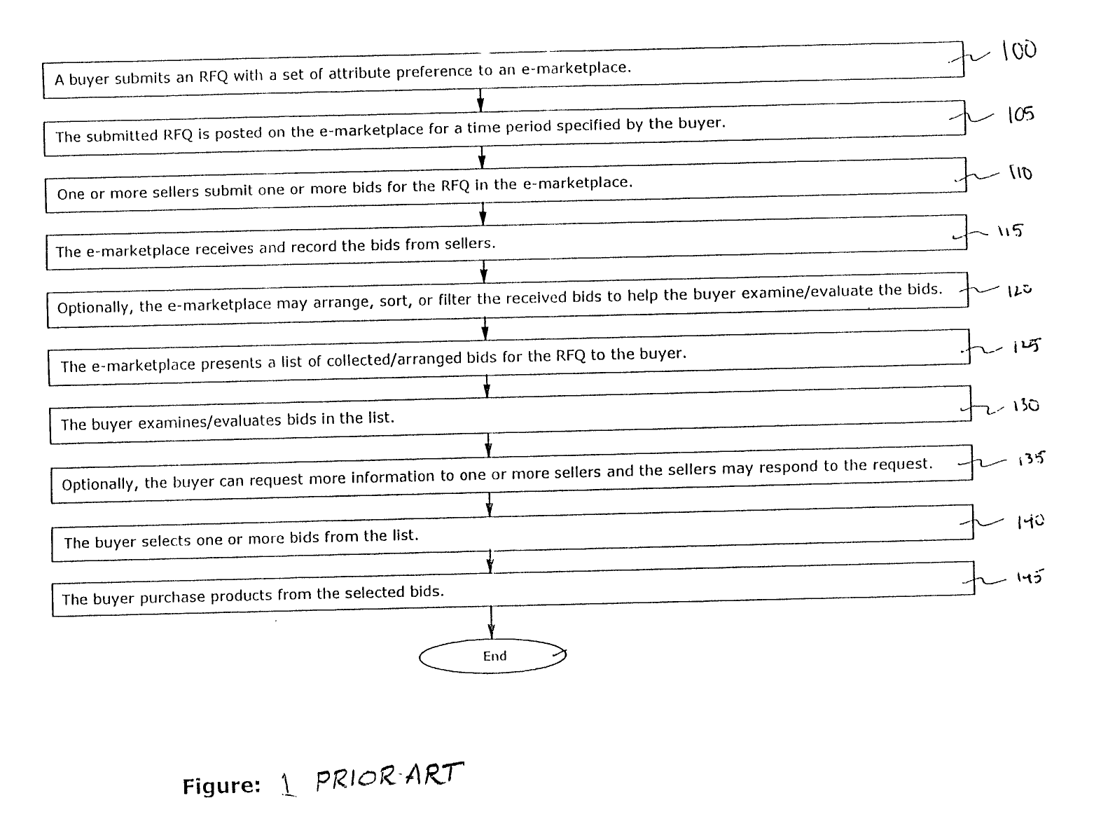

FIG. 2 is a conventional list of sell bids ranked by score;

FIG. 3 is a block diagram of a system architecture of an electronic marketplace used with the method of the present invention;

FIG. 4 is a flow chart of a RFQ process of the present invention;

FIG. 5 is a visual interface of sell bids using the method of the present invention;

FIG. 6 is a visual interface of sell bids with a filtered dominated sell bid of the present invention;

FIG. 7 is a visual interface of sell bids with a filtered attribute of the present invention;

FIG. 8 is a visual interface which filters sell bids by using a business rule of the present invention;

FIG. 9 is a visual interface which shows brief information of a sell bid of the present invention;

FIG. 10 is a visual interface which shows attribute values of a sell bid in text of the present invention;

FIG. 11 is a visual interface which shows a tagged line of a sell bid of the present invention;

FIG. 12 is a visual interface which shows detailed information of a sell bid of the present invention;

FIG. 13 is a visual interface which shows the number of bid lines displayed in the interface of the present invention; and

FIG. 14 is a visual interface which shows a mechanism for enlarging and reducing the size of the view of bid lines of the present invention.

### DETAILED DESCRIPTION OF A PREFERRED EMBODIMENT OF THE INVENTION

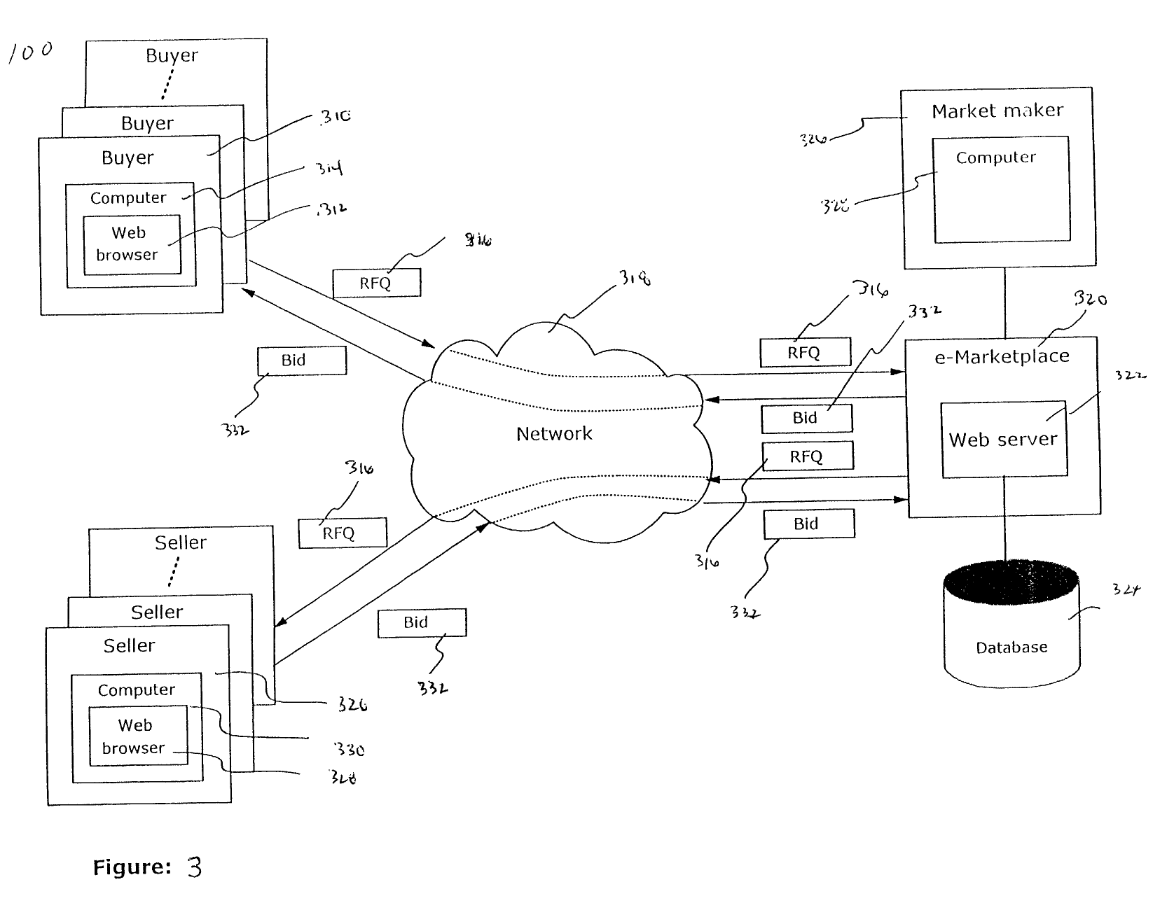

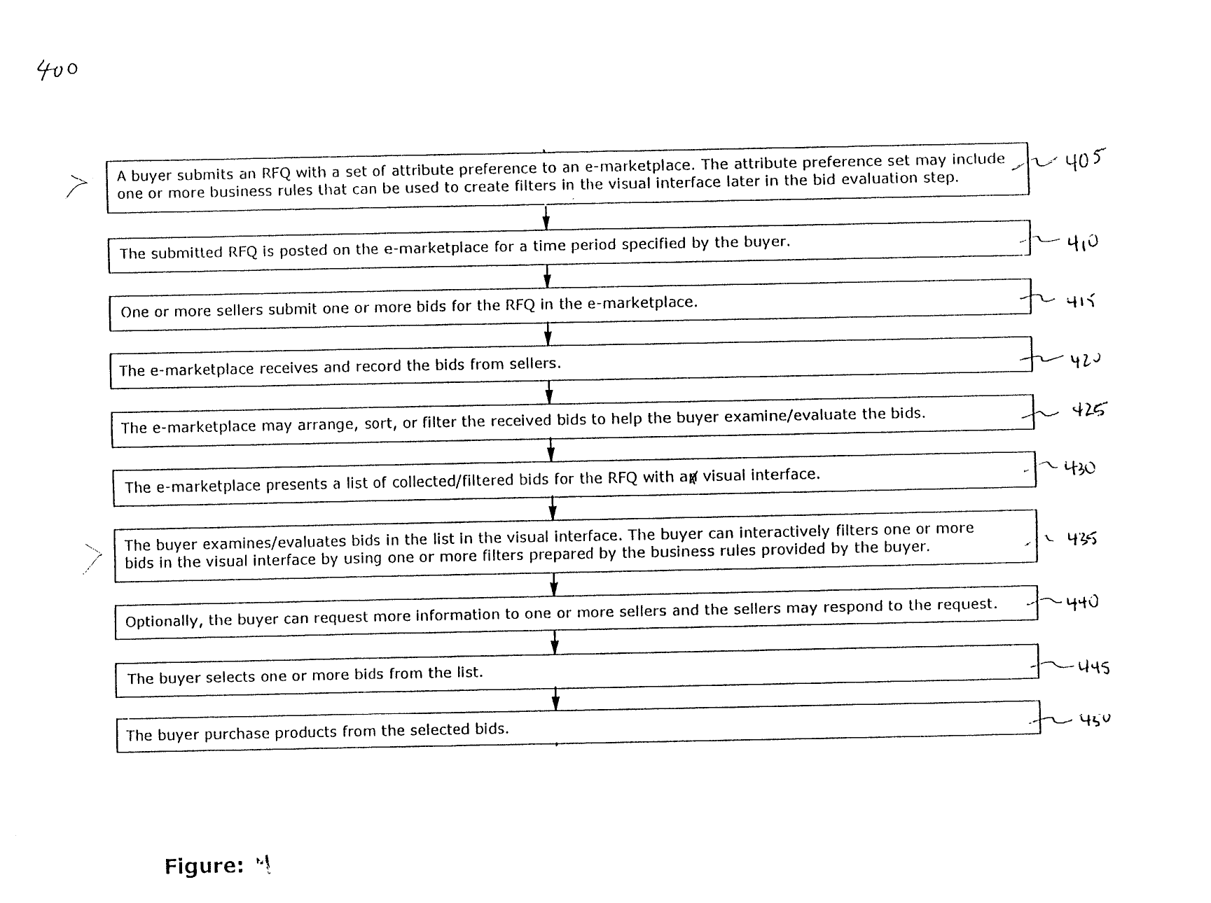

Referring now to the drawings and more particularly to FIG. 3, a block diagram of the system architecture of an e-marketplace is provided. In FIG. 3, the architecture of the e-marketplace includes one or more buyers 310 accessing Web browser programs 312 via one or more computers 314. The buyers 310 submit Request for Quotations (RFQ) 316 (and accompanying attributes as discussed with reference to FIG. 4) via the web browser programs 312 over a network 318 to an e-marketplace 320 preferably implemented by a web server 322. The web server 322 stores the RFQ 316 as well as other information such as, for example, product catalogs, seller and buyer information and the like in a database system 324. A market maker 326 may operate the e-marketplace 320 via a computer 330. Once the RFQ 316 is submitted, the e-marketplace 320 will post the RFQ 316 as a new market on the web server 322.

One or more sellers 326 may access the e-marketplace 320 over the network 318 via a web browser program 328 residing on a seller computer 330. The web browser programs 312 and 328 of both the buyer 310 and the seller 326, respectively, as well as the web server 322 preferably use HyperText Transfer Protocol (HTTP). The sellers 326 may find and access the posted RFQ 316 via the web browser program 328, and thereafter submit one or more sell bids 332 having attribute values to the e-marketplace 322 via the network 318. The sell bid 332 and associated attribute values may be stored in the database 324 as well as transmitted to the buyer's web browser 312 over the network 318. Also, the web pages associated with both of the web browser programs 312 and 330 may provide a structured form for entering the appropriate information such as, for example, the RFQ and the submitted bids.

FIG. 4 is a flow chart showing the method of the present invention implemented using the system architecture of FIG. 3. It should be understood by those of skill in the art that the e-marketplace as well as the other components of FIG. 3 are adapted to implement the steps of FIG. 4. Also, FIG. 4 can equally represent a high level block diagram capable of implementing the steps provided therein.

In general, the method of the present invention allows the buyer 310 to provide one or more business rules (conditions) as part of an attribute preference set. The market maker 326 can use these attributes to create a visual interface customized for individual RFQs showing all the attributes of the RFQ. The business rules may also be augmented in the visual interface in a form of dynamic filters. The buyer 310 can then interactively select or deselect the filters in order to change the display in an effort to compare sell bids 332 having different attribute values. The filtering may include filtering an attribute value, an attribute line associated with an attribute, a bid line (representing connected attribute values for a single bid) or a portion of the bid line.

More specifically, in step 405, the buyer 310 submits one or more business rules to the e-marketplace 320 as part of an attribute preference set which describes the buyer preferences for various relevant factors. The one or more business rules specify one or more constraints on one or more attributes of the product or service. The various factors (i.e., attributes) important to the buyer may include, but are not limited to, price, quantity, volume discount policy, material quality, product quality ratings, merchant reputation, warranty, support, delivery time, delivery cost and other factors.

The business rules of step 405 may also express various relationships among attributes of products or services. By way of specific example, the buyer 310 may have a business rule describing that the buyer is willing to pay more for a product if a seller can deliver the product of interest overnight while other conditions remain the same. This particular business rule specifies a relationship between price and delivery time. These and other business rules will be used by the market maker 326 to create a visual interface augmented by customized filters of the business rules which are later used to evaluate bids. The customized filters may filter an attribute value, an attribute line (associated with a buyer attribute), a bid line (representing connected attribute values submitted by the seller) or a portion of the bid line.

In step 410, the submitted RFQ is posted on the e-marketplace 320 for a time period specified by the buyer 310. In step 415, one or more sellers 326 submit one or more bids 332 for the RFQ in the e-marketplace 320. The submitted bids may also be accompanied by attribute values associated with attributes of the buyer, and which are later used by the buyer to determine an appropriate bid. In step 420, the e-marketplace 320 receives the bids 332 and attribute values) and stores such bids 332 and attribute values in the database 324. In step 425, the e-marketplace 320 may arrange, sort or filter the received bids 332 in order to assist the buyer 310 in examining and evaluating such bids 332.

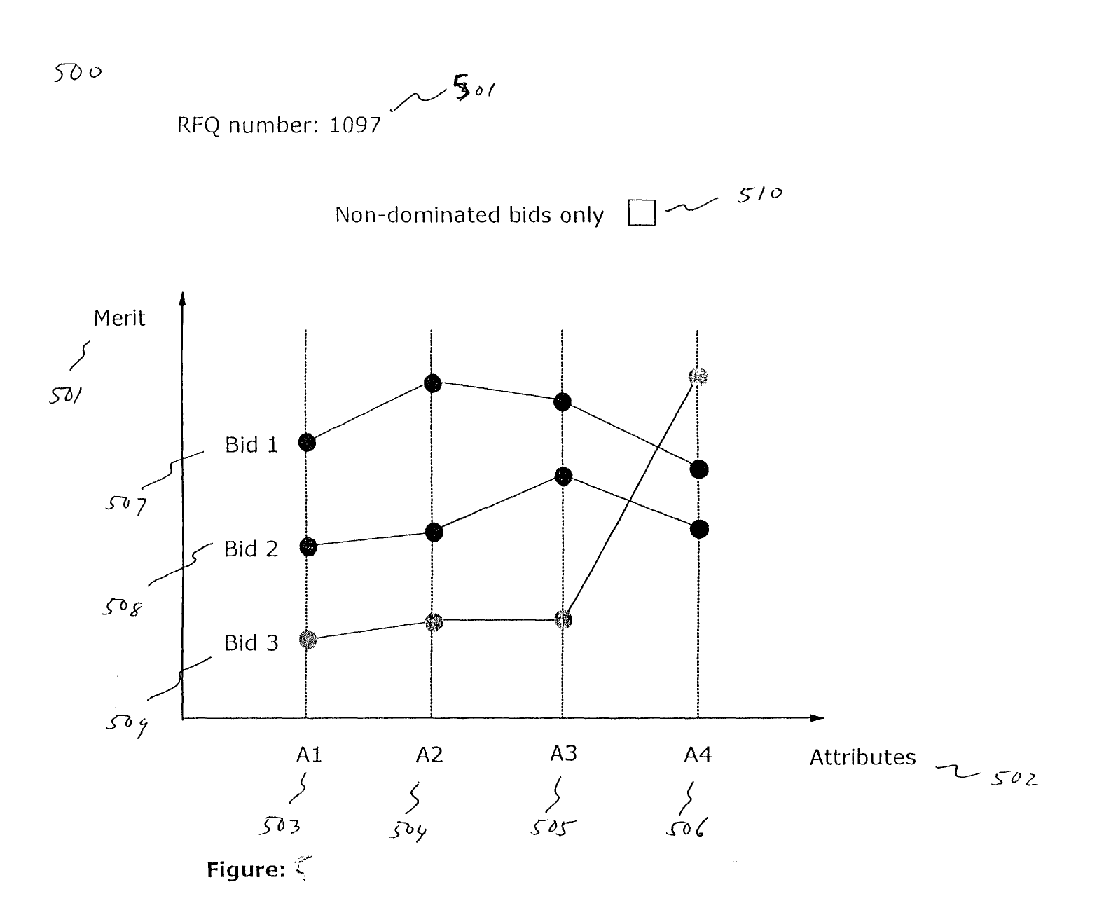

In step 430, the market maker 326 of the e-marketplace 320 creates a visual interface customized for individual RFQs showing all the attributes of the RFQ and related attribute values of individual sell bids 332 in a single screen by using a parallel coordinate system. FIGS. 5-8 show several interfaces implemented by the present invention which have the attributes and attribute values for evaluation by the buyer. The business rules specified by the buyer 310 at step 405 are also augmented in the visual interface in a form of dynamic filters. These filters may be implemented using sorting-key algorithms, as discussed below.

In step 435, the buyer 310 interactively selects or de-selects filters representing one or more business rules in order to change the display of the given parallel coordinate-based visual interface. The changes in the display may include a reordering of the attributes or attribute values. This allows the buyer 320 to compare the sell bids 332 having different attribute values, thus determining the most desirable bid.

In step 440, the buyer may optionally request more information about one or more of the sell bids. After finishing the evaluation of sell bids, in step 445, the buyer selects one or more sell bids from the given list. Finally, in step 450, the buyer purchases products or services from the selected sell bids.

FIG. 5 shows a visual interface of sell bids implemented using the method of the present invention. In FIG. 5, a display of sell bids 332 with a visual interface showing the RFQ number 501 that identifies a specific buyer RFQ is provided. A Cartesian coordinate system having an x-axis 502 shows one or more attributes 503, 504, 505 and 506 specified by the buyer 310 in the attribute preference set at the RFQ submission step 405 of FIG. 4. An example of attributes displayed on the x-axis 502 include price, quantity, material quality, product quality ratings, merchant reputation, warranty, support, delivery time, and delivery cost. Note that each attribute on the x-axis 502 is preferably represented by a equally-distanced separate line parallel (known as an attribute line) to the y-axis 501.

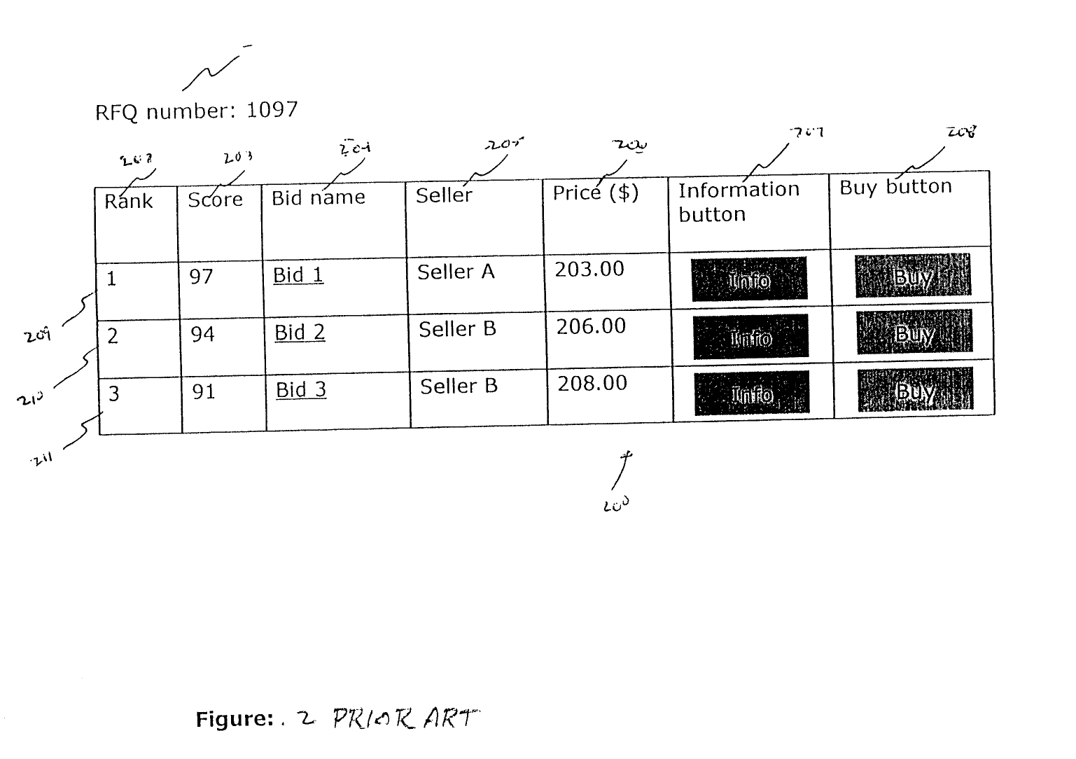

Still referring to FIG. 5, a y-axis 501 shows one or more attribute values of bids submitted by the sellers 326. Each attribute value of a bid is marked on the attribute line, and the attribute values of a bid 332 on the attribute lines are connected by a line. These lines represent a sell bid and are preferably referred to as a sell bid line as represented by reference numerals 507, 508, and 509. The sell bid lines 507, 508 and 509 may correspond to the bids 209, 210 and 211 of FIG. 2. Finally, the visual interface shows a filter 510 which allows the buyer to dynamically remove dominated bids from the interface and examine only non-dominated sell bids in the interface. In the example of FIG. 5, non-dominated bids (as represented by bid 2) are shown.

As should now be obvious to those of skill in the art, the visual interface of FIG. 5 is capable of showing all of the attributes interesting to the buyer and all of the corresponding attribute values of submitted sell bids in a single screen. This allows the buyer to effectively examine all of the relevant information and visually compare two or more sell bids by the displayed shape in the interface. Also, the method and use of the interface of the present invention provides the buyer with a set of filters based on the business rules specified by the buyer. These filters allow the buyer to interactively select or de-select one or more filters to effectively and visually compare sell bids having different attribute values.

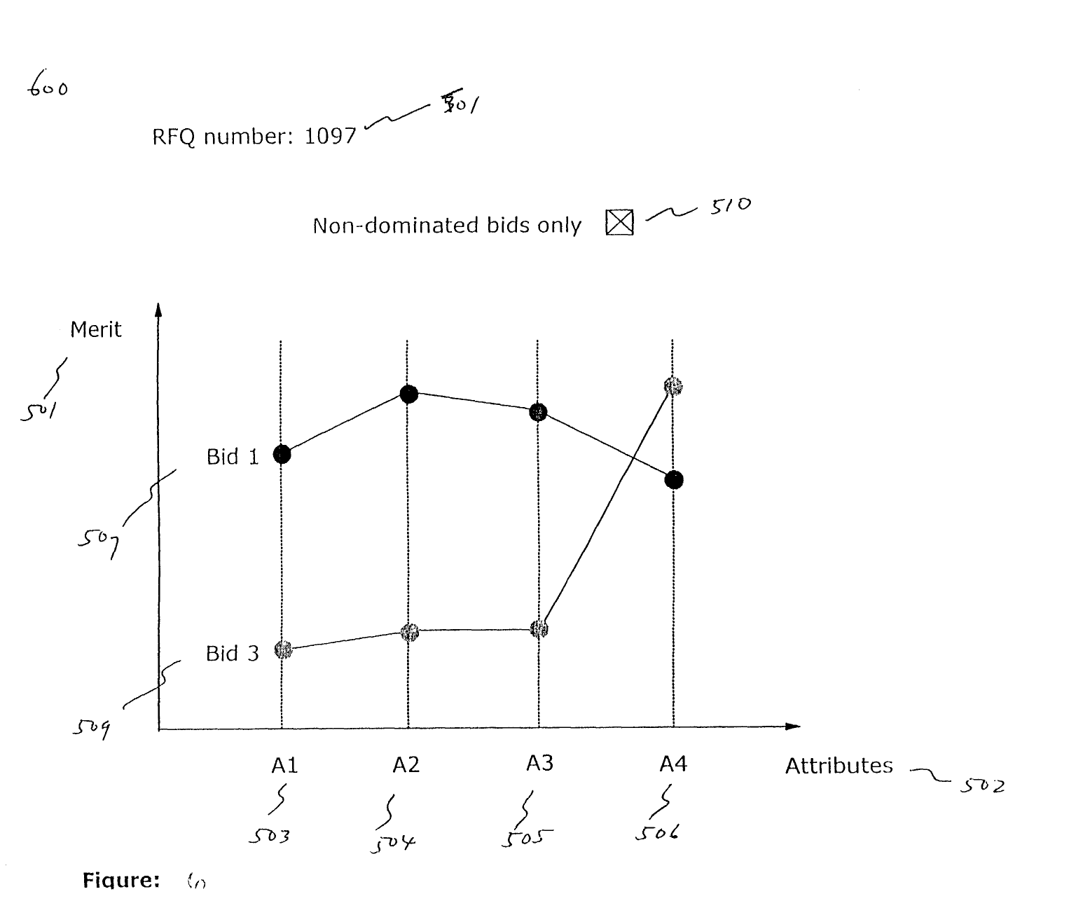

FIG. 6 shows a visual interface having filtered dominated bids. The dominated bids can be determined by using a standard multi-key sorting algorithm. That is, using a standard multi-key sorting algorithm, bids are sorted by multiple keys (i.e., multiple attribute values of bids). A bid is dominated by another bid if every key of the dominated bid is less than the corresponding key of the dominating bid in the result of the multi-key sorting.

More specifically, FIG. 6 shows a filter button 510 which allows the buyer to filter non-dominated bids. In the example of FIG. 6, bid 2 (of FIG. 5) is filtered and is thus not shown in the visual interface. (Bid 2 is dominated by bid 3 because the value of each attribute of bid 2 is “worse” or less than that of each corresponding attribute of the dominating bid 3.) In general, dominated bids need not be considered in the bid selection process by the buyer because dominated bids (e.g., bid 2) are fully represented by the dominating bids (e.g., bid 3). The buyer, however, may still determine related information such as how many dominated bids are submitted for the RFQ, and which sellers submit dominated or non-dominated sell bids.

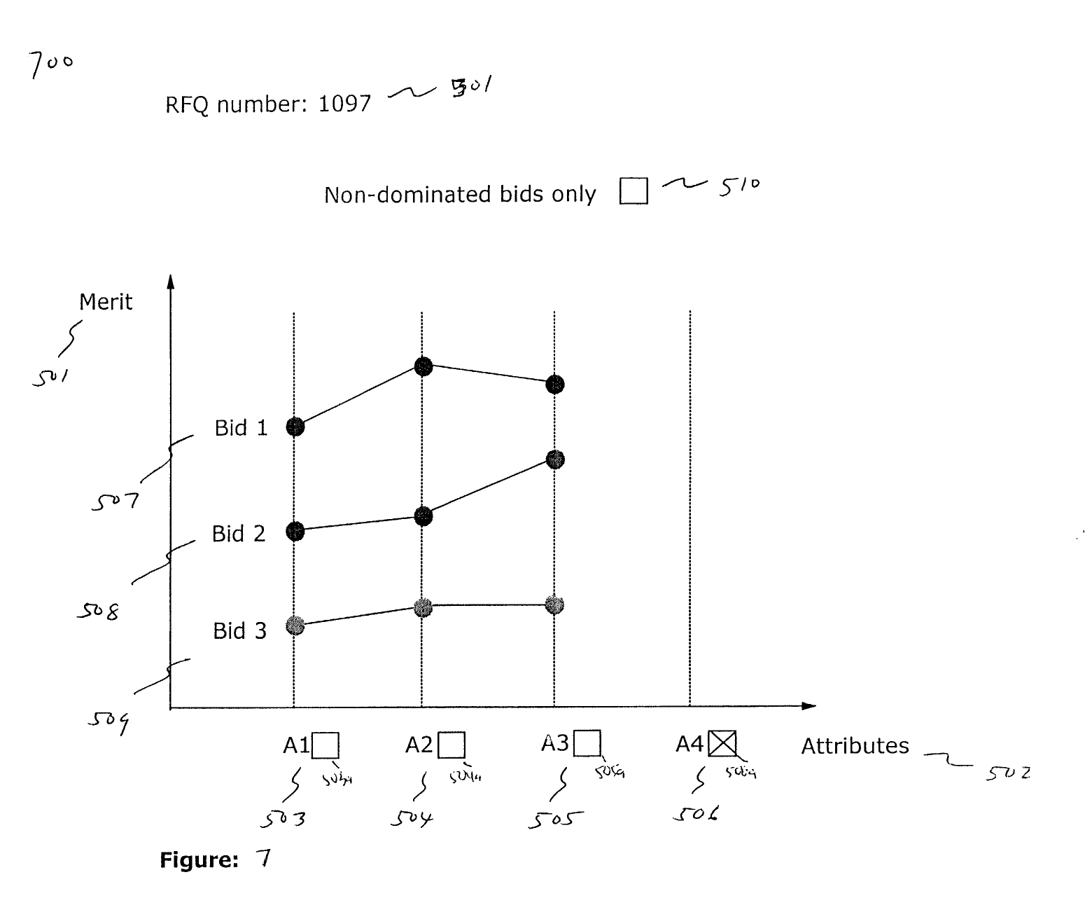

FIG. 7 is a visual interface with a filtered attribute. As shown in FIG. 7, the filtering capability of the present invention is not limited to filtering of dominated and non-dominated bids, but may also be used to filter individual attributes. This can be accomplished by augmenting each attribute in the interface with a select/de-select button 503a, 504a, 505a and 506a. In the case of FIG. 7, attribute A4 (button 506a) is deselected and the attribute values of displayed bids for A4 are thus removed from the display. By using filters associated with individual attributes, the buyer can dynamically create different conditions and compare sell bids under different environments.

An additional feature that can be augmented by attributes is a reordering operation. With this operation along with attribute filters, the buyer can arrange the order of attribute lines displayed in the interface. This allows the buyer to visually detect the changes in the sell bid lines thus being able to compare sell bids under diverse circumstances. Furthermore, each attribute can be augmented by a range adjust operation. This operation allows the buyer to adjust the range of attribute values of interest and filter out sell bids which have one or more attribute values that do not fall within a desired range.

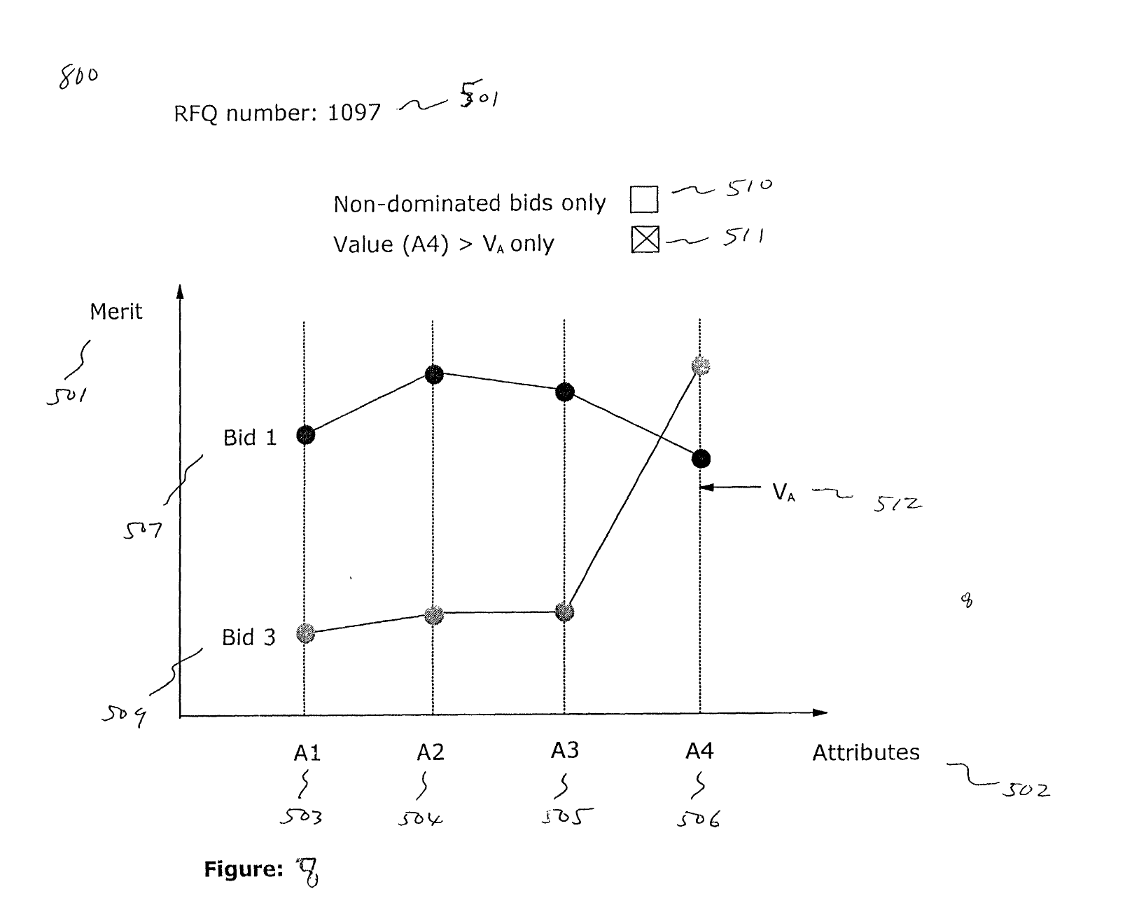

FIG. 8 is a visual interface which filters sell bids by using a business rule. To generate this display, the market maker of the e-marketplace generates one or more filters 51 1 based on the business rules specified by the buyer in the RFQ submission step 405 of FIG. 4. By allowing the buyer to interactively select or de-select one or more business rule-based filters, the interface provides related information regarding the effect of the business rules, e.g., how many sell bids are affected by a specific business rule, which sellers are affected by the business rule and the like. In the example of FIG. 8, the buyer selected a business rule that described a requirement on an attribute value which was not met by one bid, bid 2. Thus, bid 2 is removed from the visual interface.

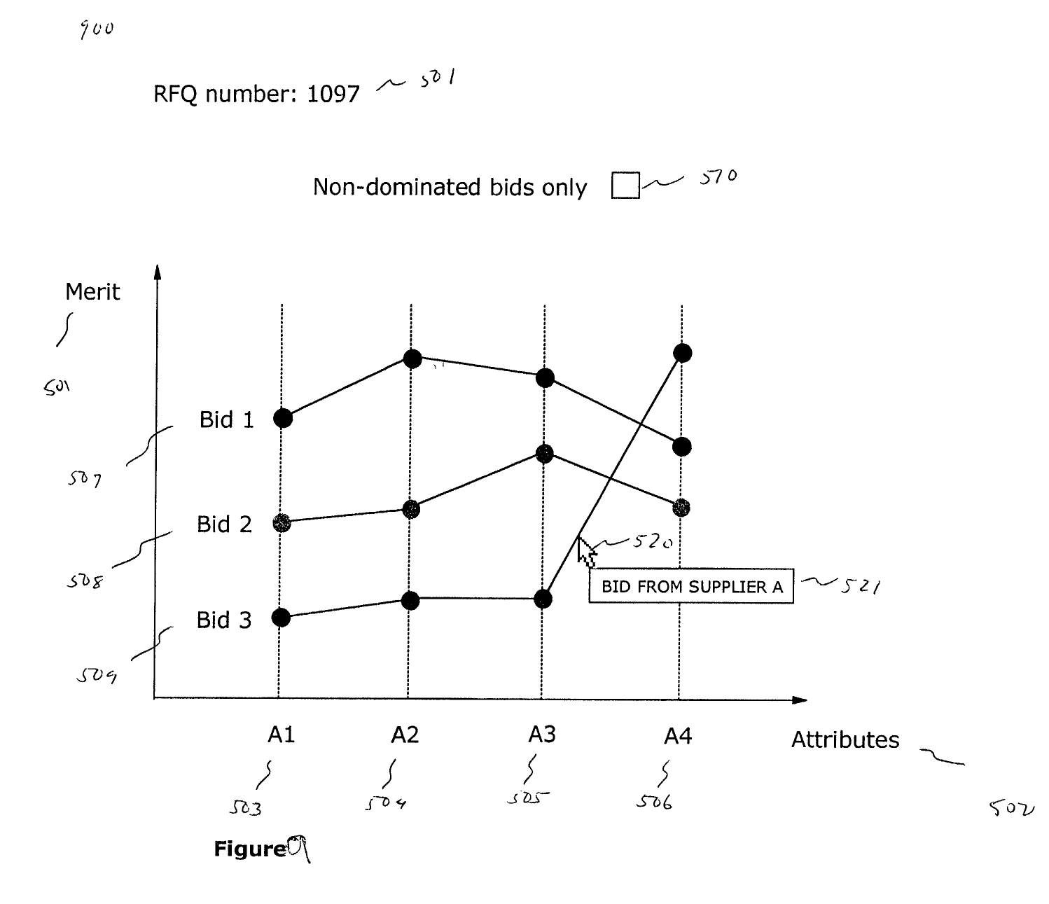

FIG. 9 is a visual interface which shows general information of a sell bid. To generate this display, the market maker of the e-marketplace 320 stores the general information of the sell bid such as, for example, seller name or identification number of the sell bid, in the database 324 of the e-marketplace system 320. A buyer triggers the view of the information associated with the sell bid in a window 521 referred to as “tooltip” by using a pointing device 520 of a computer (e.g., a mouse). Now, when the buyer points to a portion of the sell bid in the visual interface with the pointing device 520 for a predetermined amount of time, e.g., one second, the interface senses the operation, retrieves the information of the sell bid from the database 324, and renders the display of the information in the tooltip 521. By allowing the buyer to interactively view brief, but critical, information of individual sell bids with minimum effort, the visual interface is thus capable of assisting the decision-making process of the buyer. In the example of FIG. 9, the buyer points to bid 3 (509) with the pointing device 520, and brief information of bid 3, i.e., the supplier name, is displayed in the tooltip 521.

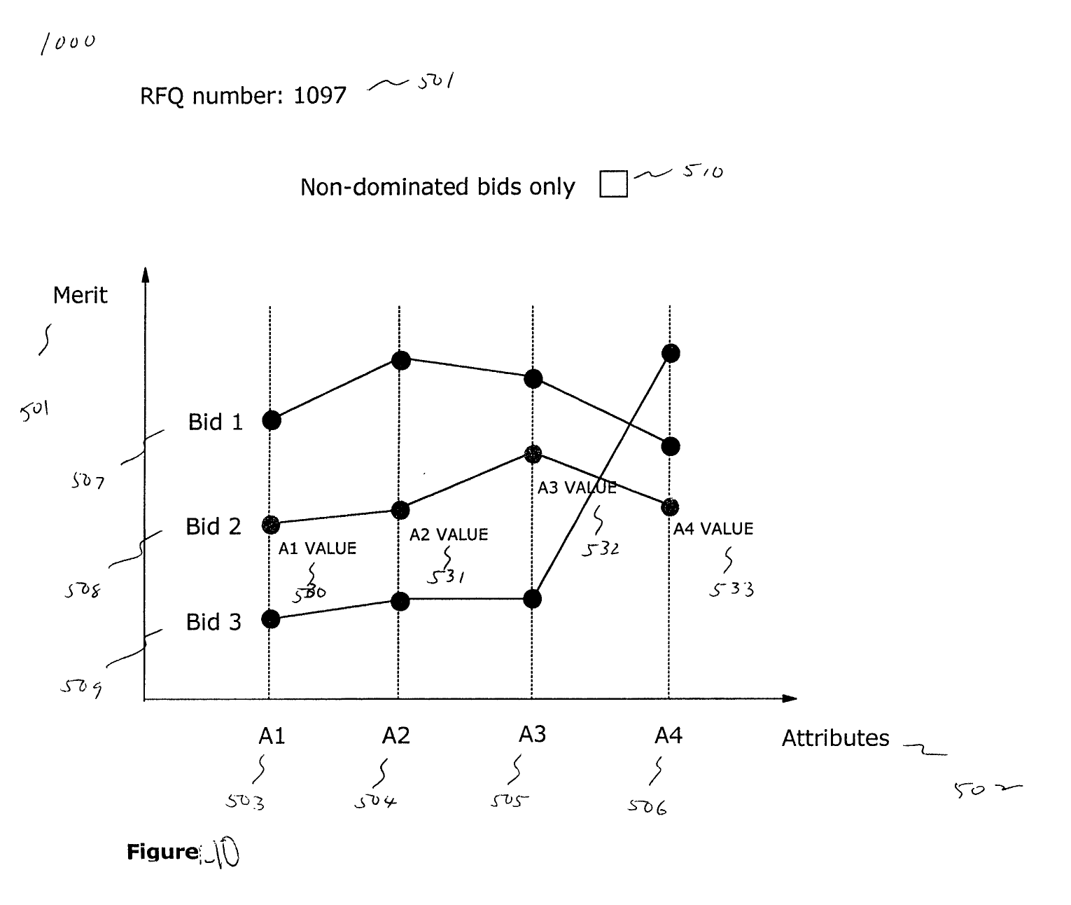

FIG. 10 is a visual interface of the present invention which shows attribute values of the sell bid. The attribute values may be displayed in text, image, animation, video, audio or other media. To generate this display, the market maker of the e-marketplace 320 stores appropriate information of sell bids such as attribute values in various media forms including text, image, audio, video, and animation in the database 324 of the e-marketplace system 320. A buyer triggers the view of the individual attribute information 530, 531, 532 and 533 of a sell bid by preferably pointing the pointing device 520 on a particular sell bid. This can be accomplished using the left button of a mouse while pointing to a portion of a sell bid. Then, the visual interface retrieves appropriate information associated with the sell bid from the database 324, and renders the display of the information preferably on or under each attribute value point of the sell bid. The buyer can remove the view of the information by, for example, re-clicking the left mouse button. Of course, other operations can also be used by the present invention to display and remove the attribute information from the display such as, for example, pressing the right mouse button or providing a certain “key” command. By allowing the buyer to interactively show and remove the view of attribute-specific information of one or more selected sell bids in various media forms, the visual interface is further capable of assisting the decision-making process of the buyer. In the example of FIG. 10, the buyer selected bid 2 (508) to display the attribute values 530, 531, 532, 533.

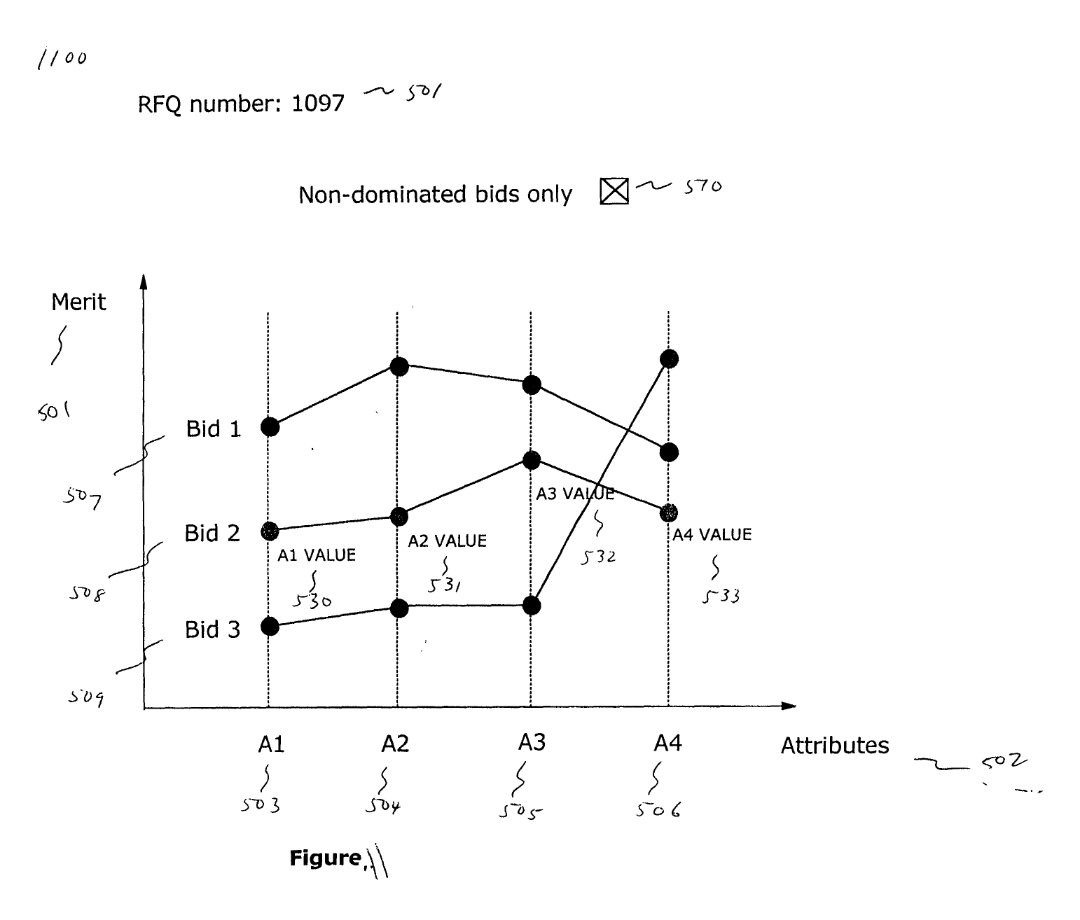

FIG. 11 is a visual interface which shows a tagged line of a sell bid. In FIG. 11, the filter button 510 is activated to allow the buyer to filter non-dominated bids. As discussed with reference to FIG. 6, the use of the filter button 520 eliminates the dominated bid 2 (508) from the visual interface bid 2; however, in the display of FIG. 11, the bid line 2 is “tagged” and thus remains displayed within the visual display. In the present invention, a buyer can tag a sell bid by a pointing operation or other command. Now, after such an operation, the dominated bid line (sell bid 2 of FIG. 11) will be unaffected by any filtering operation. In the embodiments of the present invention, the tagging may also show the attribute values of the selected bid line. The tagging is useful for a buyer to narrow down winning sell bids in the decision-making process.

The tagged bid line may be “untagged” by the buyer at any time during the viewing of the visual interface. The “untagging” of the selected bid line will allow removal of the filtered bid line from the visual interface. This can be accomplished using any known operation such as, for example, re-clicking the mouse button on the desired tagged sell bid line.

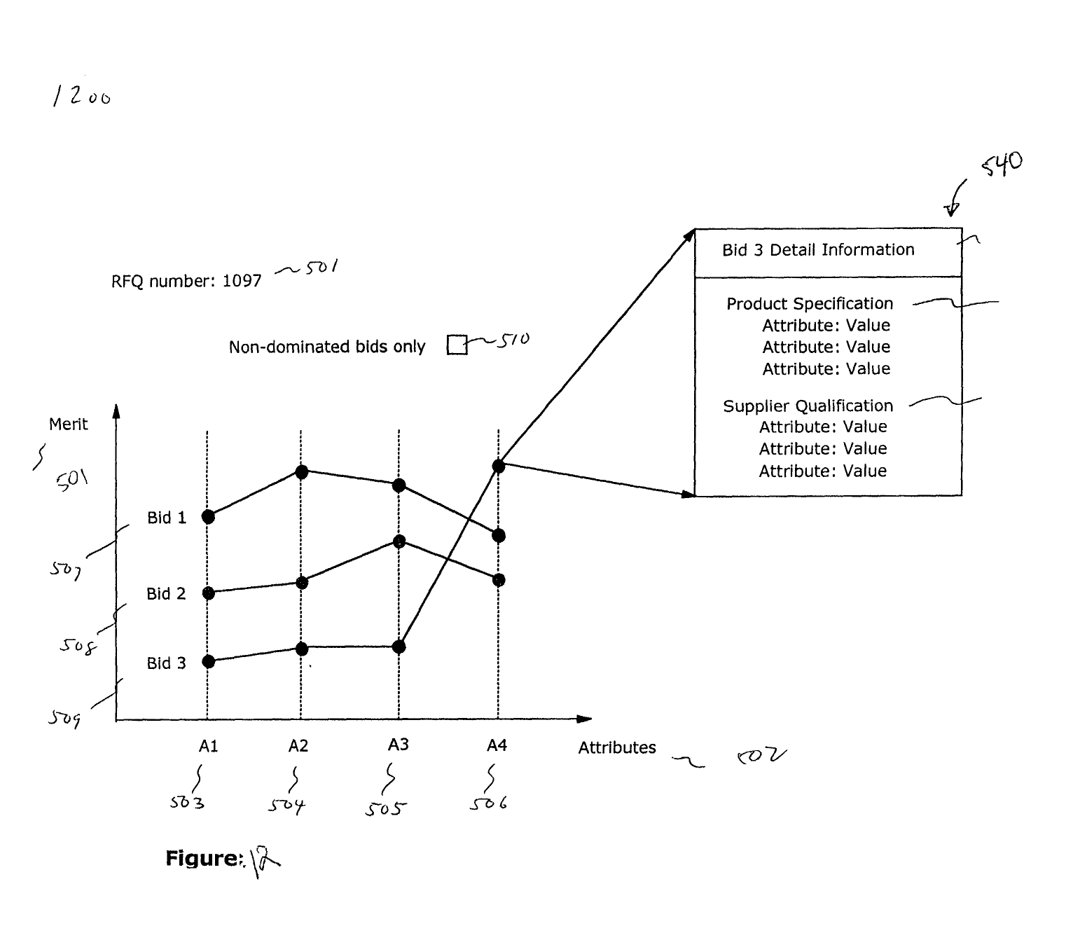

FIG. 12 is a visual interface which shows detailed information of a sell bid. In this embodiment, a “pop-up” window 540 shows detailed information about the sell bid of bid line 3. The window 540 is preferably displayed separate from the remaining portions of the visual interface. The detailed information relating to any of the displayed sell bid lines may equally be displayed using the present invention.

To generate the display of FIG. 12, the market maker of the e-marketplace 320 stores the detailed information associated with sell bids in the database 324 of the e-marketplace system 320. The detailed information, provided in the separate window 540, may be provided by, for example, clicking a left button of a mouse on a portion of a sell bid line. The visual interface retrieves the desired detailed information of the sell bid from the database 324, and thereafter creates and displays the window 540 separate from the visual interface. The window 540 may include such information as product specifications, supplier qualifications, service specification and associated attribute values and the like associated with the sell bid. To remove this displayed information, the buyer can use any known conventional “close-the-window” operation. The displayed information may be text as well as other media including image, audio, animation, and video. By allowing the buyer to interactively view rich information of one or more selected sell bids in various media forms, the visual interface further assists the decision-making process of the buyer.

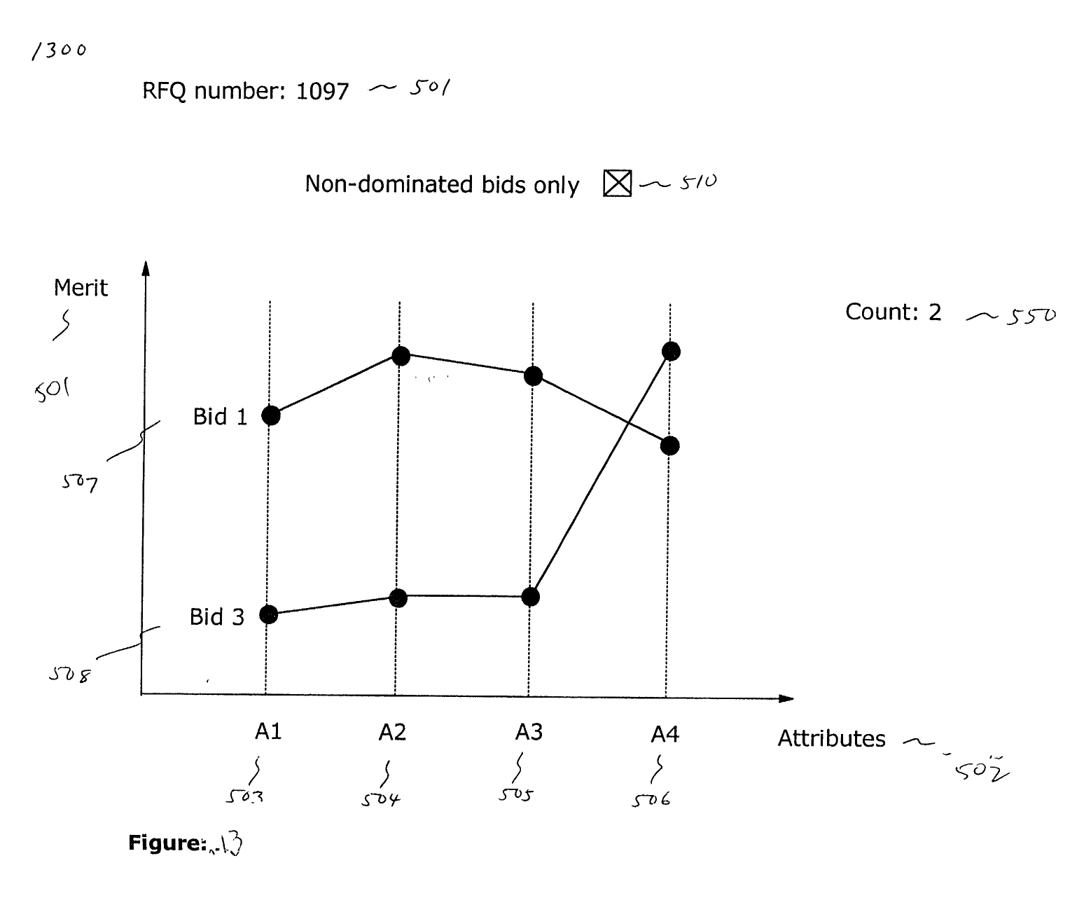

FIG. 13 is a visual interface which provides a count of the number of bid lines displayed in the visual interface. In FIG. 13, the count is represented by reference numeral 550, and is displayed as “2” (representing bid lines 1 and 3). The visual interface of the present invention includes a process which may continuously count the number of bid lines currently shown in the visual interface. By showing the count 550, the visual interface is capable of assisting the buyer in determining the current status of the buyer's decision-making process. Also, the count may be used in conjunction with the business rules or purchasing policies of the buyer organization to limit the number of sell bids to a predetermined amount in accordance with a specified business rule or policy. The business rule or policy may be stored in the database 324 and retrieved by the present invention in order to generate the display of FIG. 13.

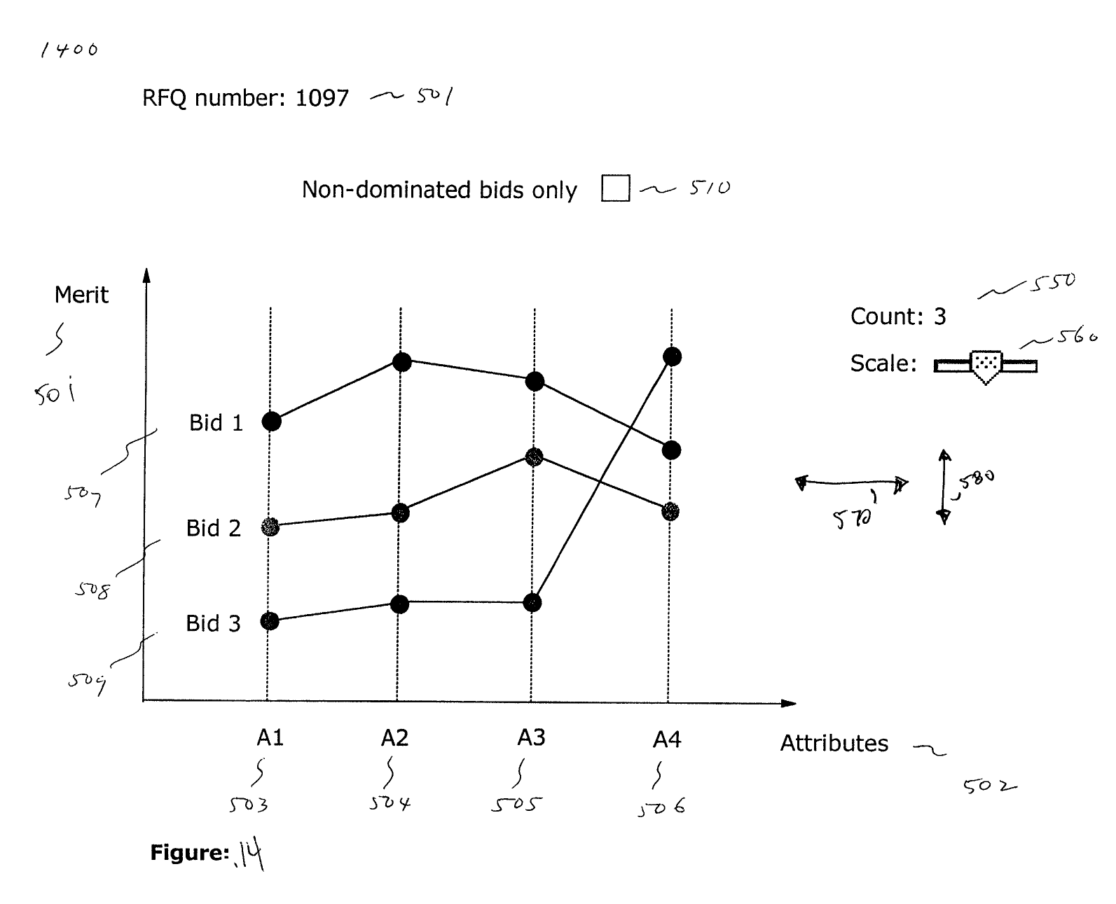

FIG. 14 is a visual interface which shows a mechanism for enlarging or reducing (scaling) the size of sell bid lines in the visual interface. FIG. 14 also shows the count 550. Often in an RFQ environment, the number of bids and the number of attributes are large, e.g., a couple of hundred bids having twenty or more attributes. When accommodating a large number of bids having a large number of attributes, the sell bids displayed in the visual interface may become large or complex. The present invention is thus capable of scaling the visual interface to a desired and/or viewable size. That is, the present invention is capable of reducing a large view to fit a computer screen, or enlarging a portion of the display for a buyer to examine specific details of the enlarged portion. The ability to interactively scale the view will allow the buyer to detect patterns in the visualized data set which may have been previously unrecognized. The scaling of the visual interface may be accomplished via a sliding bar, scroll-bar or other such mechanism. The entire visual display may also be scrolled up, down, left or right as shown by arrows 570 and 580.

While the invention has been described in terms of several embodiments, those skilled in the art will recognize that the invention can be practiced with other modification within the spirit and scope of the appended claims.

Having thus described our invention, what we claim as new and desire to secure by letters patent is as follows:

1. A method of purchasing products and services over a network comprising the steps of:
submitting a Request for Quotation (RFQ) with at least one attribute over the network;
receiving at least one bid in response to the RFQ over the network, each of the at least one bid having at least one attribute value associated therewith;
creating a graphical visual interface based on a Cartesian coordinate system, the graphical user interface showing a relationship in a graphical format between the at least one attribute and the at least one bid and associated attribute value in a single display; and
displaying information pertinent to a selected bid of the at least one bid.

2. The method of claim 1, wherein the graphical format are sell bid lines representative of selected connected attribute values of the at least one bid.

3. The method of claim 1, wherein the information is one of a general information and detailed information related to the at least one bid.

4. The method of claim 3, further comprising the steps of:
selecting a portion of a selected sell bid line created from connected attribute values of the at least one bid; and
retrieving the general or detailed information from a database, the general or detailed information being pertinent to the selected sell bid line.

5. The method of claim 4, wherein the retrieved general information is provided in a window adjacent the selected sell bid line.

6. The method of claim 4, further comprising the steps of:
creating a display separate from the graphical visual interface; and
displaying the detailed information in the separate display.

7. The method of claim 6, wherein the detailed information is rendered in one of text, image, audio, sound, video, graphs and animation.

8. The method of claim 1, wherein the information is attribute information associated with at least one sell bid line created by connected attribute values of the at least one bid.

9. The method of claim 8, further comprising the steps of:
selecting a portion of a selected sell bid line; and
retrieving the attribute information from a database for display.

10. The method of claim 9, wherein the attribute information is one of text, image, audio, sound, video, graphs and animation.

11. The method of claim 1, further comprising the steps of:
tagging at least one sell bid line created from connected attribute values of the at least one bid; and
displaying the tagged at least one sell bid line on the graphical visual interface after a selected filtering operation.

12. The method of claim 11, wherein the graphical information is at least one attribute value associated with the tagged at least one sell bid line.

13. The method of claim 11, further comprising the steps of:
untagging the at least one sell bid line; and
removing the untagged at least one sell bid line from the graphical visual interface in response to the selected filtering operation.

14. The method of claim 1, further comprising the step of displaying a count of bid lines associated with the at least one bid, the count being displayed on the graphical visual interface.

15. The method of claim 14, further comprising the steps of continuously counting the number of bid lines and displaying the counted number of bid lines in the graphical visual interface.

16. The method of claim 1, further comprising the steps of enlarging or reducing a portion of the graphical visual interface.

17. The method of claim 16, wherein the enlarging or reducing steps show portions of sell bid lines representative of connected attribute values of the at least one bid.

18. The method of claim 1, further comprising the step of scrolling the graphical visual interface in a desired direction.

19. A method of purchasing products and services over a network comprising the steps of:
submitting a Request for Quotation (RFQ) with at least one attribute over the network;
receiving at least one bid in response to the RFQ over the network, each of the at least one bid having at least one attribute value associated therewith;
creating a graphical visual interface based on a Cartesian coordinate system, the graphical user interface showing a relationship in a graphical format between the at least one attribute and the at least one bid and associated attribute value in a single display, wherein the graphical format are sell bid lines created from connected attribute values of the at least one bid; and
tagging at least one sell bid line of the sell bid lines, wherein the tagged at least one sell bid line remains displayed on the graphical visual interface after a selected filtering operation.

20. The method of claim 19, further comprising the steps of:
untagging the at least one sell bid line; and
removing the untagged at least one sell bid line from the graphical visual interface in response to the selected filtering operation.

21. The method of claim 19, further comprising the step of providing information pertinent to the tagged at least one sell bid line.

22. A system for purchasing products and services over a network comprising:
means for submitting a Request for Quotation (RFQ) with at least one attribute over the network;
means for receiving at least one bid in response to the RFQ over the network, each of the at least one bid having at least one attribute value; and
means for creating a graphical visual interface based on a Cartesian coordinate system showing a relationship in a graphical format between the at least one attribute and corresponding attribute value in a single display; and
means for providing information associated with a selected bid of the at least one bid.

23. The system of claim 22, wherein the information is one of general information, detailed information and attribute information.

24. The system of claim 23, further comprising:
means for selecting a portion of a selected sell bid line representative of connected attribute values of the at least one bid; and
means for retrieving the general or detailed information from a database, the general or detailed information being pertinent to the selected sell bid line.

25. The system of claim 24, further comprising:
means for creating a display separate from the graphical visual interface; and
means for displaying the detailed information in the display.

26. The system of claim 22, further comprising means for tagging at least one sell bid line, created from connected attribute values of the at least one bid, the tagged at least one sell bid line being displayed on the graphical visual interface after a selected filtering operation.

27. The system of claim 22, further comprising:
means for counting bid lines created from connected attribute values of the at least one bid; and
means for displaying the counted bid lines.

28. The system of claim 22, further comprising means for enlarging or reducing a portion of the graphical visual interface.

29. The system of claim 22, further comprising means for scrolling the graphical visual interface in a desired direction.

30. A machine readable medium containing code for purchasing products and services over a network, the code implementing the steps of:
submitting a Request for Quotation (RFQ) with at least one attribute over the network;
receiving at least one bid in response to the RFQ over the network, each of the at least one bid having at least one attribute value;
creating a graphical visual interface based on a Cartesian coordinate system, the graphical user interface showing a relationship in a graphical format between the at least one attribute and the at least one bid and associated attribute value in a single display; and
providing information associated with a selected bid of the at least one bid.
